(19) United States
(12) Patent Application Publication
(10) Pub. No.: US 2024/0163747 A1
(43) Pub. Date: May 16, 2024

(54) Communication With Mobile Radio Base Stations

(71) Applicant: Telefonaktiebolaget LM Ericsson (publ), Stockholm (SE)

(72) Inventors: Tommy Arngren, Sodra Sunderbyn (SE); Peter Okvist, Lulea (SE); Hans Hannu, Lulea (SE); Stefan Wanstedt, Lulea (SE)

(21) Appl. No.: 18/281,923

(22) PCT Filed: Mar. 17, 2021
(86) PCT No.: PCT/SE2021/050234

§ 371 Date: Sep. 13, 2023

(51) Int. Cl. H04W 36/00

(52) U.S. Cl. CPC H04W 36/00835

(57) ABSTRACT

The present disclosure relates to a method of a radio base station (101) of communicating with a neighbouring radio base station (104), and a radio base station (101) performing the method. In an aspect, a method of a radio base station (101) is provided of communicating with a neighbouring radio base station (104). The method comprises establishing (S101) communication with said neighbouring radio base station (104) and acquiring (S102), from the neighbouring radio base station (104), information identifying at least one other radio base station (102) within an area (100) that the neighbouring radio base station (104) is aware of.

### TECHNICAL FIELD

The present disclosure relates to a method of a radio base station of communicating with a neighbouring radio base station, and a radio base station performing the method.

### BACKGROUND

Provision of cellular coverage in scenarios where communication infrastructure has been impaired, e.g., in natural disaster areas, is important, both for survivors and aftermath civilian life as well as for rescue actions.

One way to provide coverage is via deployment of airborne wireless radio base stations utilized to temporarily provide data-, voice- and text services in such areas.

However, as compared to conventional and fixedly deployed radio base stations, mobility management is a greater challenge with the deployment of airborne radio base stations. For instance, determining when to handover a wireless communication device from one base station to another is more challenging since not only are the wireless communication devices mobile, but so are the base stations. There is thus room for improvement in this field.

### SUMMARY

One objective is to solve, or at least mitigate, this problem in the art and to provide an improved method of a radio base station of communicating with a neighbouring radio base station.

This objective is attained in a first aspect by a method of a radio base station of communicating with a neighbouring radio base station. The method comprises establishing communication with said neighbouring radio base station and acquiring, from the neighbouring radio base station, information identifying at least one other radio base station within an area that the neighbouring radio base station is aware of.

This objective is attained in a second aspect by a radio base station configured to communicate with a neighbouring radio base station, comprising a processing unit and a memory, said memory containing instructions executable by said processing unit, whereby the radio base station is operative to establish communication with said neighbouring radio base station and to acquire, from the neighbouring radio base station, information identifying at least one other radio base station within an area that the neighbouring radio base station is aware of.

This objective is attained in a third aspect by a method of a mobile radio base station of communicating with a neighbouring radio base station. The method comprises establishing communication with said neighbouring radio base station and providing the neighbouring radio base station with information identifying at least one other radio base station within an area that the radio base station is aware of.

This objective is attained in a fourth aspect by a radio base station configured to communicate with a neighbouring radio base station, comprising a processing unit and a memory, said memory containing instructions executable by said processing unit, whereby the radio base station is operative to establish communication with said neighbouring radio base station, and to provide the neighbouring radio base station with information identifying at least one other radio base station within an area that the radio base station is aware of.

Advantageously, a radio base station (be it a stationary or mobile radio base station) communicating with a neighbouring base station over an interface such as the commonly known X2 interface may request the neighbouring base station to share information identifying other base stations in a given area that the neighbouring base station is aware of. If the radio base station wishes to establish communication with one or more of these other radio base stations, for instance for handing over a wireless communication device, said base station may proceed with establish the communication over e.g. X2 using the acquired information.

In an embodiment, in case the radio base station is a mobile radio base station, such as an aerial radio base station, the establishing of the communication is performed when the distance to the neighbouring base station is less than a predetermined distance value.

In an embodiment, the communication is established over an X2 interface, and the method further comprises acquiring an identifier of the neighbouring base station either by instructing a wireless communication device served by the radio base station to perform an Automatic Neighbour Relation (ANR) procedure or by acquiring an identifier of the neighbouring base station with which the radio base station has been preconfigured.

In an embodiment, the information further comprises identifiers of cells served by said at least one other radio base station within the area.

In an embodiment, the information identifying cells served by said at least one other radio base station within the area comprises Physical Cell Identifiers (PCIs).

In an embodiment, the information identifying at least one other radio base station within an area comprises a Target Cell Identifier (TCI) or a Cell Global Identifier (CGI).

In an embodiment, the method further comprises updating a Neighbour Cell Relation Table (NCRT) with the acquired information and storing the updated NCRT.

In an embodiment, the method further comprises updating an NCRT with the acquired information and sending the updated NCRT to a central entity for storage.

In an embodiment, the method further comprises one or more of (a) coordinates indicating an assigned radio coverage area of the neighbouring radio base station, (b) a timestamp indicating a time when the neighbouring radio base station acquired the information identifying said at least one other radio base station within the area and (c) current coordinates of the neighbouring radio base station.

In an embodiment, the updating of an entry in the NCRT is performed if the timestamp of the received information for said entry indicates that the received information is more current than the information already stored for said entry in the NCRT.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 illustrates a prior art radio base station deployment;

FIG. 2 shows a signalling diagram illustrating establishing of a connection over X2 interface as performed in the art;

FIG. 3 illustrates a radio base station deployment comprising mobile radio base stations and stationary radio base stations according to an embodiment;

FIG. 4 shows a signalling diagram illustrating a method of communicating among mobile radio base stations and stationary radio base stations according to an embodiment;

FIG. 5 illustrates a radio base station deployment comprising mobile radio base stations and stationary radio base stations being assigned coverage areas according to an embodiment;

FIG. 6 shows a signalling diagram illustrating the use of time stamps according to an embodiment;

FIG. 7 illustrates a further embodiment, where continuously updated information shared between radio base stations is uploaded to a central entity; and

FIG. 8 illustrates a radio base station according to an embodiment.

### DETAILED DESCRIPTION

The aspects of the present disclosure will now be described more fully hereinafter with reference to the accompanying drawings, in which certain embodiments of the invention are shown.

These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

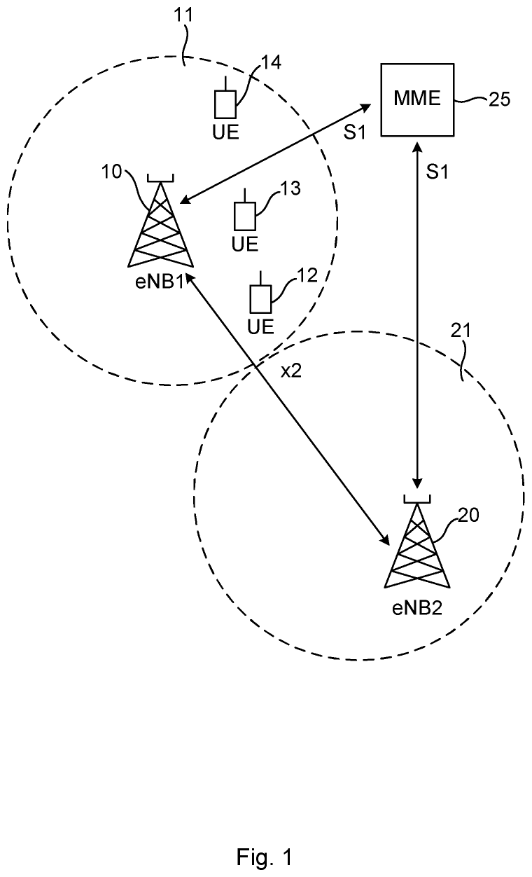

FIG. 1 illustrates a prior art deployment where a first radio base station 10 (RBS) forms a first coverage area 11, or radio cell, serving a plurality of wireless communication devices 12-14 embodied in the form of e.g. smart phones, tablets or connected vehicles. A neighbouring second RBS 20 forms a second coverage area 21, or radio cell, serving a plurality of wireless communication devices 22-24.

An RBS 10, 20 is generally referred to as a Node B, eNodeB or gNB depending on whether it is implemented in third generation (3G) Universal Mobile Telecommunications System (UMTS), fourth generation (4G) Long Term Evolution (LTE) or fifth generation (5G) New Radio (NR).

In the following, the RBSs will be referred to as eNBs while the wireless communication devices will be referred to as User Equipment (UE).

Now, the eNBs 10, 20 are capable of communicating over an interface referred to as X2 using an appropriate communication protocol; in for instance LTE, this protocol is referred to as the X2 Application Protocol (X2AP). For instance, the eNBs 10,20 may use the X2 interface to share load information to help spread traffic load more evenly, indicate radio link failure in a cell, acquire information indicating frequency bands deployed in neighbouring cells, transit user data and perform mobility management, etc.

Assuming for instance that UE 12 moves from the first cell 11 and towards the second cell 21; the first eNB 10 will thus handover the UE 12 to the second eNB 20 which thereafter will be responsible for serving the UE 12. The control signalling for effecting the handover is performed via the X2 interface, where the first eNB 10 effectively will instruct the second eNB 20 to assume the responsibility for serving the UE 12.

In order for an eNB to establish communication over the X2 interface, the eNB needs to be aware of which other RBSs are located nearby (in practice an eNB will neighbour on a plurality of other eNBs, even though FIG. 1 for illustrative purposes only shows two eNBs).

The eNB may be preconfigured with such information or use a functionality referred to as Automatic Neighbour Relation (ANR). In ANR, the eNB will instruct one or more UEs located in its cell to detect all the cells around it, and report required neighbouring cell information. This information typically comprises a so-called Target Cell Identifier (TCI). In Evolved-UMTS Terrestrial Radio Access Network (E-UTRAN), the TCI corresponds to a E-UTRAN Cell Global Identifier (ECGI) and Physical Cell Identifier (PCI) of a target cell.

Thus, the first eNB 10 may instruct the UE 12 to perform ANR, wherein the UE 12 will report the TCI or the ECGI of the second eNB 20 to the first eNB 10 which in its turn will store the information in a Neighbour Cell Relation Table (NCRT). It is noted that an eNB may serve a plurality of cells meaning that the first eNB 10 will store a post in the NCRT for each cell served by the second eNB 20; in E-UTRAN, an eNB will be identified by the above-mentioned ECGI and each cell will be identified by a PCI. The NCRT will hence include the ECGI of each neighbouring eNB and the corresponding PCIs of any cells served by the neighbouring eNBs.

As is understood, the ANR approach relieves an operator from the burden of manually managing neighbour cell relations. In the following, this will be described from an E-UTRAN perspective.

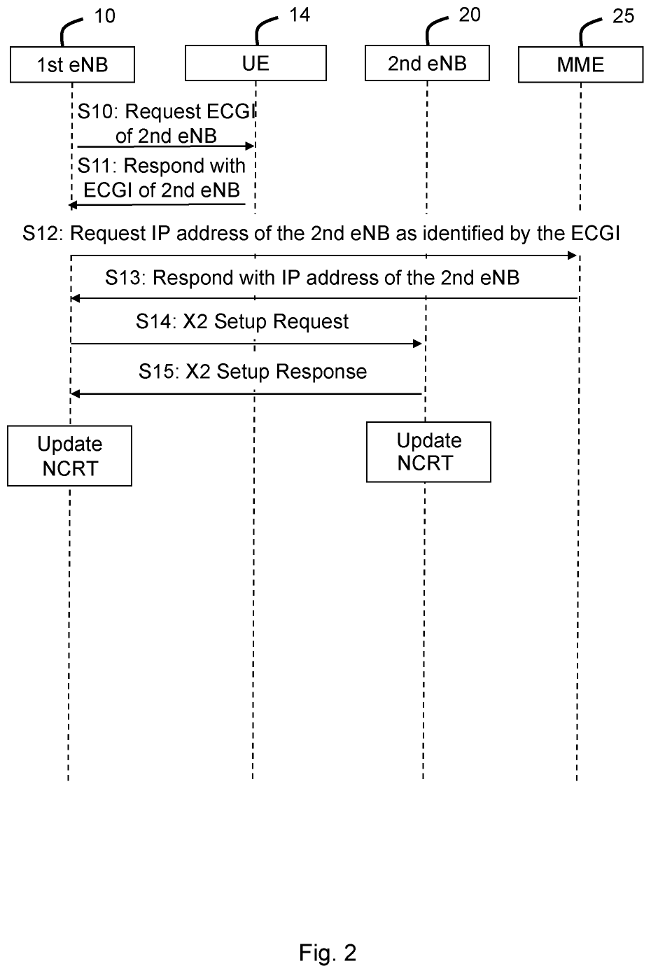

FIG. 2 shows a signalling diagram illustrating the ANR process and the establishing of a connection between the first eNB 10 and the second eNB 20 over the X2 interface as performed in the art.

When the UE 12 moves from a cell 11 (aka. source cell) served by the first eNB 10 towards a cell 21 (aka. target cell) served by the neighbouring second eNB 20, the first eNB 10 will check its NCRT and acquire the ECGI of the target cell 21, as previously reported by the UE 12, in order to contact the second eNB 20 over the X2 interface for handover of the UE 12.

However, assuming that the first eNB 10 at this point does not have access to the ECGI of the second eNB 20; ANR will thus be performed by the first eNB 10 requesting the UE 12 to report the ECGI of the second eNB 20 in step S10, to which the UE 12 responds in step S11 with the requested ECGI. The eNB 20 may thus update its NCRT with the ECGI or send a request to an external operations, administration and management (OAM) system to update the NCRT and await a response from the OAM system to perform the NCRT update. The OAM system (not shown in FIG. 1 or 2) may store the NCRT of a great number of eNBs.

The first eNB 10 will then in step S12 contact a Mobility Management Entity 25 (MME) over an Si interface to acquire an IP address of the second eNB 20 in step S13 (unless the first eNB 10 has been preconfigured with the IP address of the second eNB 20).

Thereafter, the first eNB 10 contacts the second eNB 20 over the X2 interface in step S14 using the acquired IP address by sending an X2 Setup Request. The X2 Setup Request comprises the ECGI and PCI(s) of the first eNB 10.

The second eNB 20 will reply in step S15 with an X2 Setup Response comprising the PCI(s) of cell(s) served by the second eNB 20. The first eNB 10 will thus update its NCRT by adding the PCIs for this corresponding ECGI, and the second eNB 20 will similarly update its NCRT by adding the ECGI of the first eNB 10 along with the corresponding PCIs.

Thus, with the X2 Setup Request of step S14, the first eNB 10 notifies the second eNB 20 over the established X2 connection that the UE 12 will be handed over from the source cell 11 served by the first eNB 10 to the target cell 21 served by the second eNB 20. Typically, hand-over communication would include sharing various information over the X2 interface such as e.g. current frequency bands used in the cells.

As is understood, with the deployment of FIG. 1 with stationary eNBs, NCRTs are fairly static with the occasional update when e.g. a UE roams a previously unknown territory thereby reporting a previously non-encountered cell or when an eNB performs antenna tilting thereby changing the radio coverage (and hence the physical constitution) of the cell.

In contrast, with non-stationary, movable eNBs, for instance in the form of aerial eNBs, i.e. unmanned aerial vehicles (UAVs) providing radio base station functionality, this obviously becomes more complex since not only the UEs but also the aerial eNBs themselves are mobile.

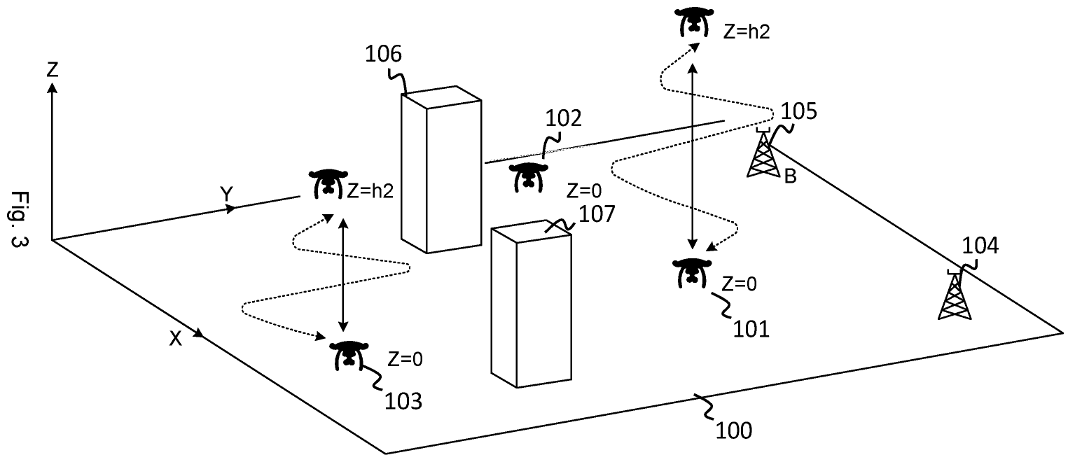

FIG. 3 illustrates mobile eNBs according to an embodiment. In this exemplifying embodiment, a given area 100 is served by five eNBs; three eNBbs 101-103 are aerial (referred to as aeNBs in the following) while two eNBs are conventional stationary eNBs 104, 105. As indicated in FIG. 3, the aeNBs 101-103 move over the area 100 in an x-y direction, but may further move at different altitudes z from ground level to altitude h2. Included in the Figure is further two high-rise buildings 106, 107 that the aeNBs 101-103 must consider when moving over the area 100.

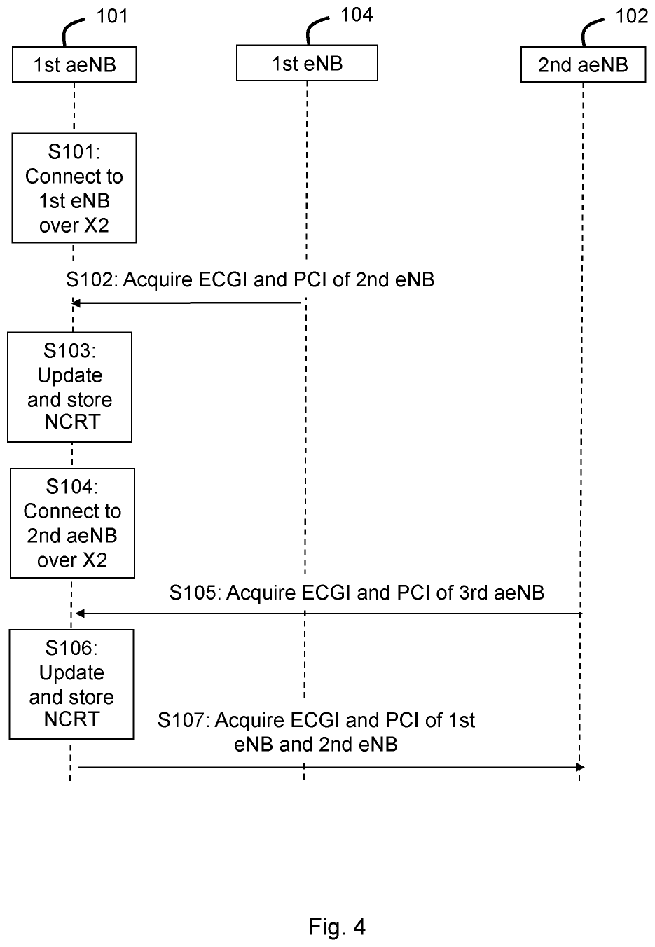

Reference will further be made to FIG. 4 showing a signalling diagram illustrating a method of an aeNB of communicating with other aeNBs and eNBs in the area according to an embodiment.

Now, assuming that first aeNB 101 moves towards first eNB 104 and acquires an identifier of the first eNB 104, in the following exemplified by means of the ECGI uniquely identifying the first eNB 104.

As previously described, the aeNB 101 may either have been preconfigured with the ECGI or may acquire the ECGI of the first eNB 104 by requesting the information from a UE (not shown in FIG. 3) being served by the aeNB 101 utilizing ANR as described in steps S10 and S11 of FIG. 2.

At this stage, the aeNB 101 will—using the ECGI of the first eNB 104—set up a connection with the first eNB 104 over an X2 interface in step S101 using the X2 Setup Request/Response procedure, typically after having made a transport network layer (TNL) address lookup request to an MME over an Si interface for the IP address of the first eNB 104 identified by means of the ECGI, as previously described throughout steps S12-S15 in FIG. 2.

In case the aeNB 101 is preconfigured with the ECGI of the first eNB 104, the aeNB 101 may advantageously (after having performed the address lookup with the MME) connect with the first eNB 104 over the X2 interface without having to interact with a UE. For the aeNB 101 to instruct a UE to perform ANR, the aeNB 101 must indeed encounter the UE within the current operational area of the aeNB 101 and further the UE must have access to the ECGI of the first eNB 104 for the ANR procedure to be successful.

As is understood, the aeNB 101 will typically only perform this process if the aeNB 101 is within a certain distance D from the first eNB 104; an X2 interface is setup between neighbouring base stations and if for instance the first aeNB 101 is far away from the first eNB 104, such as at another end of the area 100, the first aeNB 101 will not setup communication with the first eNB 104 over X2.

Thus, after having set up the connection in step S101 over the X2 interface, the first aeNB 101 and the first eNB 104 will exchange PCIs, and the first eNB 104 will also receive the ECGI of the first aeNB 101, as in the art.

However, in this embodiment, the aeNB 101 will request the first eNB 104 to share its NCRT in step S102. Hence, the aeNB 101 will acquire, from the first eNB 104, information identifying (in this example the ECGI) other aeNBs/eNBs within the area 100.

Advantageously, if the first eNB 104 already has access to the ECGI (and PCI(s)) of second eNB 105, the aeNB 101 will now also be given access to the ECGI identifying the second eNB 105 and update its NCRT accordingly. The new updated NCRT is stored in step S103.

If not, the aeNB 101 may approach the second eNB 105 and repeat the procedure just performed for the first eNB 104 in order to acquire the information.

However, assuming that the aeNB 101 now has updated its NCRT with the ECGIs and PCIs of the first eNB 104 and the second eNB 105, the first aeNb 101 moves towards second aeNB 102, where the first aeNB 101 will apply ANR to have one of the UEs it serves to report the ECGI of the second aeNB 102, or by preconfiguring the first aeNB 101 with the ECGI of the second aeNB 102, such that an X2 Setup Request/Response procedure may be performed as described with reference to steps S10-S15 of FIG. 2. This is illustrated with step S104 of FIG. 4.

Assuming that the second aeNB 102 already has approached third aeNB 103 at the other end of the area 100 and thus acquired the ECGI and any PCI(s) of the third aeNB 103; the first aeNB 101 may thus request the second aeNB 102 to share its NCRT in step S105—or at least one or more entries relevant for the first aeNB 101—thereby giving the first aeNB 101 access to the ECGI/PCI of the third aeNB 103. The first 101 aeNB updates its NCRT and stores the updated NCRT in step S106 accordingly.

As is understood, this is advantageously achieved without even having the first aeNB 101 approach the third aeNB 103. Correspondingly, the second aeNB 102 advantageously receives the NCRT held by the first eNB 101 in step S107 and updates its NCRT with the ECGI and PCI entries of the first eNB 104 and second eNB 105 without yet having approached the two.

By having a mobile aeNB or stationary eNB continuously share NCRT entries, it is advantageously possible to enable for all aeNBs and eNBs in the area 100 to update their respective NCRT to comprise the ECGIs/PCIs of all other aeNBs and eNBs without even having approached the other base stations.

It is noted that after some time, when the aeNBs 101-103 have traversed the area 100 and performed the NCRT sharing, each base station will have access to a correct and updated NCRT. In other words, it may be envisaged that all base stations then at least temporarily will hold an identical NCRT.

The NCRT may subsequently change by for instance a new aeNB or eNB being deployed in the area 100, which would require a new ECGI to be introduced, or if the cell information of one or more base stations change, for instance in view of a base station performing antenna tilting thereby modifying the cell coverage area, which may require a PCI updated.

In such a scenario, exchange of NCRTs according to the above embodiment would soon result in all base stations storing updated NCRTs.

As is understood, even if the above described embodiments involve mobile radio base stations (“aeNBs”), the embodiments may be applied to stationary radio base stations (“eNBs”) sharing NCRTs among each other.

In an embodiment, the aeNBs 101-103 are assigned a particular area to cover. Information identifying such assigned areas are included in the information shared among the base stations comprising the base station identifiers.

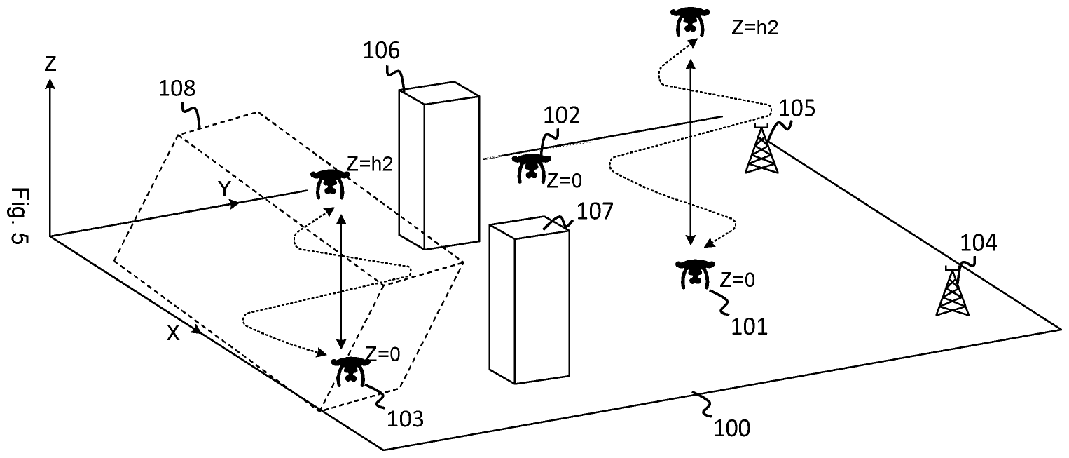

As shown in FIG. 5, the third aeNB 103 has been assigned to cover the volume denoted 108. The volume 108 is typically defined by coordinates in x, y, z space delimiting the volume 108. It may be advantageous to include the coordinates delimiting the assigned volume 108 in the information being shared. That is, in addition to sharing the ECGI and PCIs of an aeNB/eNB, the coordinates identifying the assigned volume 108 is further included.

With the information including the assigned volume 108 in which the third aeNB 103 will move and provide radio coverage, a receiving aeNB/eNB may concluded whether the third aeNB 103 in practice is candidate base station to which a UE should be handed over.

For instance, while the second aeNB 102 may have an assigned area bordering on the volume 108, the first aeNB 101 may not and thus conclude that the third aeNB 103 is not a candidate base station for handover. It should be noted that since the aeNBs are mobile, these decisions may change over time, as can the assigned areas.

Indicating an assigned area for each eaNB/eNB further facilitates for an approaching aeNB to determine that it indeed is within a certain distance D from the eaNB/eNB to which the area is assigned and as a result establish communication over the X2 interface with said eaNB/eNB.

It may further be envisaged that third aeNB 103 includes its current coordinates with the information, possibly by providing its current longitude, latitude and altitude.

In a further embodiment, a timestamp is associated with each NCRT entry to indicate at which time the entry was acquired.

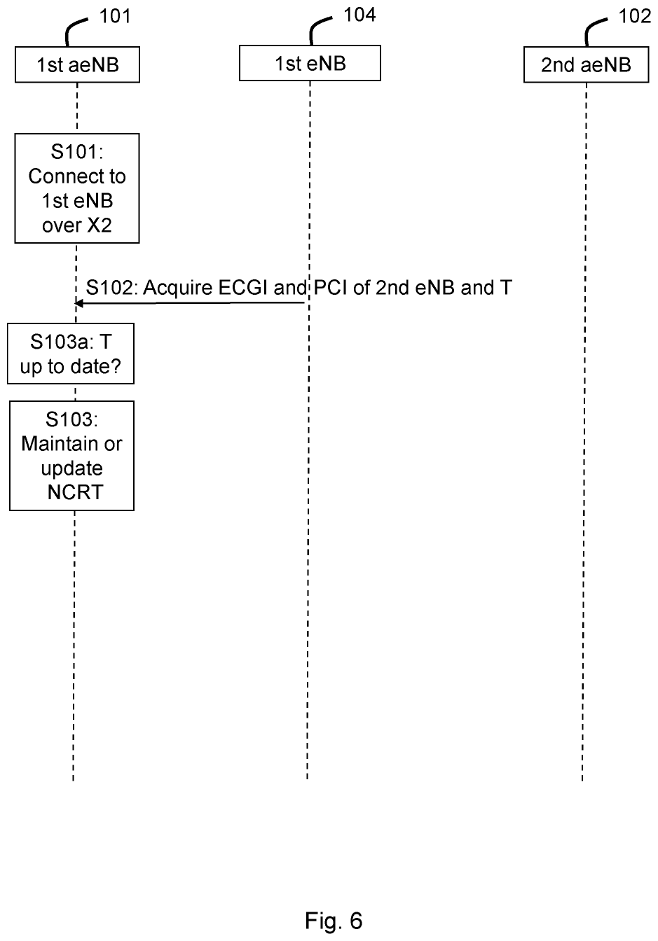

FIG. 6 shows a signalling diagram illustrating the use of time stamps according to an embodiment. In step S101, the first aeNB 101 establishes communication with the first eNB 104 using the X2 Setup Request/Response procedure and receives the NCRT of the first eNB 104 in step S102.

Before updating its stored NCRT, the first aeNB 101 concludes in step S103a that a timestamp associated with an entry of the stored NCRT, for instance the entry associated with the second aeNB 102, is more current than a timestamp associated with the same entry in the NCRT received from the first eNB 104 received in step S102.

In other words, the first eNB 101 concludes in step S103a that the NCRT entry associated with the second aeNB 102 is more current than that received and is thus likely to be correct.

When updating the NCRT in step S103, the entry associated with the second aeNB 102 will advantageously be maintained. Nevertheless, other entries of the NCRT may be updated and stored in step S103.

Thus, to illustrate, an NCRT may in an embodiment have the appearance of Table 1, showing an extended NCRT:

TABLE 1
Extended NCRT.
NCRT

| | | Time- | Designated | Current base |
|---|---|---|---|---|
| ECGI | PCI | stamp | volume | station position |
| ECGI1 | PCI 1, 2, | T1 | X1, Y1, Z1, . . . , | Xa, Ya, Za |
| | 3 | | Xn, Yn, Zn | |
| ECGI2 | PCI 1, 2 | T2 | X2, Y2, Z2, . . . , | Xb, Yb, Zb |
| | | | Xm, Ym, Zm | |
| ECGI3 | PCI 1, 2, | T3 | X2, Y2, Z2, . . . , | Xc, Yc, Zc |
| | 3, 4 | | Xl, Yl, Zl | |

Thus, not only will each NCRT entry identify a base station (by means of the ECGI) and the cells the base station serves (by means of the PCIs), but each entry may also indicate the time at which the entry information was acquired, the coordinates of the assigned area of the base station and the current position of the base station.

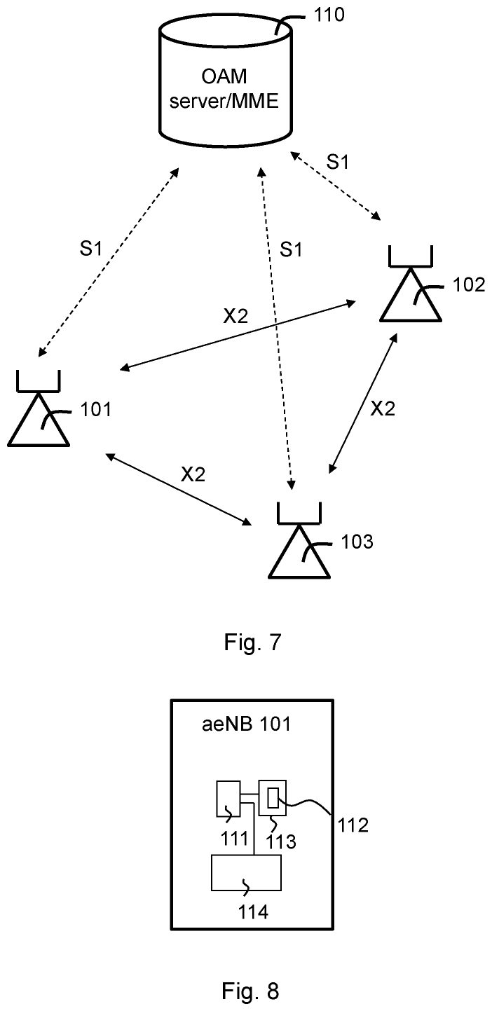

FIG. 7 illustrates a further embodiment, where the continuously updated NCRTs shared between the aeNBs 101-103 over the X2 interface is uploaded over the Si interface to a central entity such as the previously discussed MME (via control plane signalling) or even an external operations, administration and management (OAM) server 11o (via user plane signalling).

Advantageously, with this embodiment, the aeNBs 101-103 may turn to the MME/OAM server 110 at any time for an updated NCRT. This is also applicable to the stationary radio base stations. It may further be envisaged that the OAM server 11o triggers an aeNB to contact another eaNB/eNB.

It is noted that while for any two aeNBs or eNBs establishing communication over the X2 interface, the communication being setup may be wireless or wired, and may occur directly between the two, or via a core network. Even though a wireless communication is preferred in case of an aeNB, it may also be envisaged that a wire is attached to the aeNB for carrying any X2 communication data.

FIG. 8 illustrates a radio base station in the form of the first aeNB 101 according to an embodiment, where the steps of the method performed by the aeNB 101 in practice are performed by a processing unit in embodied in the form of one or more microprocessors arranged to execute a computer program 112 downloaded to a storage medium 113 associated with the microprocessor, such as a Random Access Memory (RAM), a Flash memory or a hard disk drive. The processing unit 111 is arranged to cause the aeNB 101 to carry out the method according to embodiments when the appropriate computer program 112 comprising computer-executable instructions is downloaded to the storage medium 113 and executed by the processing unit 111. The storage medium 113 may also be a computer program product comprising the computer program 112. Alternatively, the computer program 112 may be transferred to the storage medium 113 by means of a suitable computer program product, such as a Digital Versatile Disc (DVD) or a memory stick. As a further alternative, the computer program 112 may be downloaded to the storage medium 113 over a network. The processing unit in may alternatively be embodied in the form of a digital signal processor (DSP), an application specific integrated circuit (ASIC), a field-programmable gate array (FPGA), a complex programmable logic device (CPLD), etc. The aeNB 101 further comprises a communication interface 114 (wired or wireless) over which the aeNB 101 is configured to transmit and receive data.

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of a radio base station (101) of communicating with a neighbouring radio base station (104), comprising:
establishing (S101) communication with said neighbouring radio base station (104); and
acquiring (S102), from the neighbouring radio base station (104), information identifying at least one other radio base station (102) within an area (100) that the neighbouring radio base station (104) is aware of.

2. The method of claim 1, wherein the radio base station (101) is a mobile radio base station (101), and the establishing (S101) of the communication being performed when the distance to the neighbouring base station (104) is less than a predetermined distance value.

3. The method of claim 1, the communication being established over an X2 interface, the method further comprising:
acquiring an identifier of the neighbouring base station (104) either by instructing a wireless communication device served by the radio base station (101) to perform an Automatic Neighbour Relation, ANR, procedure, or by acquiring an identifier of the neighbouring base station (104) with which the radio base station (101) has been preconfigured.

4. The method of claim 1, the information further comprising identifiers of cells served by said at least one other radio base station (102) within the area (100).

5. The method of claim 4, the information identifying cells served by said at least one other radio base station (102) within the area (100) comprising Physical Cell Identifiers, PCIs.

6. The method of claim 1, the information identifying at least one other radio base station (102) within an area (100) comprising a Target Cell Identifier, TCI, or a Cell Global Identifier, CGI.

7. The method of claim 1, further comprising:
updating (S103) a Neighbour Cell Relation Table, NCRT, with the acquired information and storing the updated NCRT.

8. The method of claim 1, further comprising:
updating (S103) a Neighbour Cell Relation Table, NCRT, with the acquired information and sending the updated NCRT to a central entity (25, 110) for storage.

9. The method of claim 1, the information further comprising one or more of (a) coordinates indicating an assigned radio coverage area of the neighbouring radio base station (104), (b) a timestamp indicating a time when the neighbouring radio base station (104) acquired the information identifying said at least one other radio base station (102) within the area (100) and (c) current coordinates of the neighbouring radio base station (104).

10. The method of claim 7, wherein updating (S103) of an entry in the NCRT is performed if the timestamp of the received information for said entry indicates that the received information is more current than the information already stored for said entry in the NCRT.

11. A computer program (112) comprising computer-executable instructions for causing a radio base station (101) to perform steps recited in claim 1 when the computer-executable instructions are executed on a processing unit (111) included in the radio base station (101).

12. A computer program product comprising a computer readable medium (113), the computer readable medium having the computer program (112) according to claim 11 embodied thereon.

13. A method of a mobile radio base station (101) of communicating with a neighbouring radio base station (102), comprising:
establishing (S104) communication with said neighbouring radio base station (102); and
providing (S107) the neighbouring radio base station (102) with information identifying at least one other radio base station (104, 105) within an area (100) that the radio base station (101) is aware of.

14. A radio base station (101) configured to communicate with a neighbouring radio base station (104), comprising a processing unit (111) and a memory (113), said memory containing instructions (112) executable by said processing unit (111), whereby the radio base station (101) is operative to:
establish communication with said neighbouring radio base station (104); and
acquire, from the neighbouring radio base station (104), information identifying at least one other radio base station (102) within an area (100) that the neighbouring radio base station (104) is aware of.

15. The radio base station (101) of claim 14, wherein the radio base station (101) is a mobile radio base station (101), further being operative to establish the communication when the distance to the neighbouring base station (104) is less than a predetermined distance value.

16. The radio base station (101) of claim 15, being operative to establish the communication over an X2 interface, the radio base station (101) further being operative to:
acquire an identifier of the neighbouring base station (104) either by instructing a wireless communication device served by the radio base station (101) to perform an Automatic Neighbour Relation, ANR, procedure, or by acquiring an identifier of the neighbouring base station (104) with which the radio base station (101) has been preconfigured.

17. The radio base station (101) of claim 14, the information further comprising identifiers of cells served by said at least one other radio base station (102) within the area (100).

18. The radio base station (101) of claim 17, the information identifying cells served by said at least one other radio base station (102) within the area (100) comprising Physical Cell Identifiers, PCIs.

19. The radio base station (101) of claim 14, the information being configured to identify at least one other radio base station (102) within an area (100) comprising a Target Cell Identifier, TCI, or a Cell Global Identifier, CGI.

20. The radio base station (101) of claim 14, further being operative to:
update a Neighbour Relation Table, NCRT, with the acquired information and storing the updated NCRT.

21.-24. (canceled)
